(19) United States
(12) Patent Application Publication
(10) Pub. No.: US 2017/0166101 A1
(43) Pub. Date: Jun. 15, 2017

(54) SWAP OUT APPARATUS, METHOD AND ARTICLE OF MANUFACTURE.

(71) Applicant: Cathy Morgan, Somers Point, NJ (US)

(72) Inventor: Cathy Morgan, Somers Point, NJ (US)

(21) Appl. No.: 15/349,848

(22) Filed: Nov. 11, 2016

Related U.S. Application Data
(60) Provisional application No. 62/267,413, filed on Dec. 15, 2015.

(51) Int. Cl. B60N 3/04; B62D 65/14

(52) U.S. Cl. CPC B60N 3/048; B62D 65/14; B62D 25/2072

(57) ABSTRACT

An apparatus, method and article of manufacture for all vehicles to implement tile or heavy duty rubber interior are provided. Moreover, the disclosed apparatus is flexible and water proof. In addition, unlike carpet the disclosed apparatus and method of introducing tile or heavy duty rubber to the interior of vehicles would benefit the user by reducing odors and other toxins.

This application claims the benefit to U.S. Provisional Application No. 62/267,413, filed on Dec. 15, 2015, which application is incorporated herein by reference as if set forth in its entirety.

### FIELD OF THE INVENTION

The present invention generally relates to automotive interiors. More specifically, the present disclosure relates to an apparatus and method to implement tile or heavy duty rubber interior into motor vehicles.

### BACKGROUND OF THE INVENTION

Carpets or rug material have been one of the most common materials found on the interior floor of vehicles. Such a material is popular in other settings such as trains, planes, offices, and houses, but there are many issues that carpet and rug material present to the owner of such location. Maintenance is one of the many issues faced by owners of vehicles with carpeted interiors. Carpet or rug interiors are more difficult than other materials to upkeep as spills or debris can leave noticeable stains or odors to the carpet.

### DETAILED DESCRIPTION OF THE INVENTION

One embodiment includes a vehicular flooring apparatus to be used in lieu and place of carpeted flooring. The apparatus comprises one or more tiles constructed in a manner to be installed in one or more flooring areas of a vehicle to thereby provide finishing surface to the one or more flooring areas of the vehicle; said one or more tiles having a first surface area, a second surface area and peripheral lips provided on side edges of the configuration of the tile; wherein the characteristics of the one or more tiles conform to the geometry and function of the specific area of the vehicle.

Another embodiment comprises a method for installing a vehicular flooring apparatus. The method recites the steps of: (a) preparing a flooring area of a vehicle to install a tile by adhering to preparation recommendations for a corresponding tile; (b) obtaining the geometry associated with said flooring area; (c) preparing the tile by adhering to preparation recommendations for the corresponding tile; (d) placing said tile in a specific location within said flooring area; and (e) repeating steps a-d until said flooring area is fully covered.

Another embodiment comprises an article of manufacture. The article of manufacture comprises a vehicular flooring tile having a firs surface area, a second surface area and peripheral lips provided on side edges of the configuration of the tile, wherein the tile incorporate characteristics adapted to the interior architecture of vehicle.

### BRIEF DESCRIPTION OF THE DRAWINGS

The teachings of the present invention can be readily understood by considering the following detailed description in conjunction with the accompanying drawings, in which:

FIG. 1 depicts an exemplary Vehicle Tiled Floor according to an embodiment;

FIG. 2A depicts an illustrative perspective of the Vehicle Tile according to an embodiment;

FIG. 2B depicts an illustrative bottom view of the Vehicular Tile according to an embodiment;

FIG. 3 depicts an exemplary front view of the Vehicular Tile according to an embodiment;

FIG. 4 depicts an exemplary rear view of the Vehicular Tile according to an embodiment;

FIG. 5 depicts an exemplary right side view of the Vehicular Tile according to an embodiment; and

FIG. 6 depicts an exemplary left side view of the Vehicular Tile according to an embodiment.

To facilitate understanding, identical reference numerals have been used, where possible, to designate identical elements that are common to the Figures.

### DETAILED DESCRIPTION

The present disclosure provides for changing the interior flooring of all vehicles from having carpet or rug to installing tile or heavy duty rubber in lieu and place of carpet. The present disclosure describes a vehicular tile that is flexible and water proof in its preferred embodiment. Moreover, the emphasis is herein placed on introducing tile or heavy duty rubber into the interior of vehicles, which would benefit the user by not collecting or reducing odors and other toxins. Car interiors are actually toxic all year round. However, the chemicals are at their highest levels when the car is brand new and during the summer months. Newly manufactured materials still carry some residue from production and compounds get released as the car's parts start to be used for example, seats being sat in, dashboard controls being touched and carpet being rubbed. As a result of these chemicals, the “new car smell” is developed. The excess levels of chemicals start to wear off over time. These chemicals however, reside in the car in places such as the carpeting of the car. These chemicals are being released in much lower doses and during the hot summer days some of these toxic fumes start to get stirred up and released again. This process is called “offgassing.” The interior carpeting provides a hide away place for these toxic fumes, which can be trapped and encapsulated within the fiber of the carpet. In addition, such vehicular tile would not be as easily damaged by spills as carpets would be. Lastly, the disclosed embodiments also provide the owner of the vehicle a more modern and industrial look to their vehicle's interior.

With the advent of nanotechnology, the tile herein disclosed can be perfected for the interior of a vehicle incorporating qualities that a conventional tile or carpet simply lacks. For example, the tile can be made very light, brittle or pliable depending on the requirements of the area of the vehicle where the tile will be installed. Second, the disclosed tile can be made to absorb noise better than carpet, or the disclosed tile can shield heat better than carpet or a conventional tile and the disclosed tile can be made using organic and non-toxic materials.

The invention will be primarily described within the context of particular embodiments; however, those skilled in the art and informed by the teachings herein will realize that the invention is also applicable to other technical areas and/or embodiments.

The illustrative apparatus, method and article of manufacture embodiments described herein are not meant to be limiting. It may be readily understood that certain aspects of the disclosed apparatus, method and article of manufacture can be arranged and combined in a variety of different configurations, all of which are contemplated herein.

Generally speaking, the various embodiments enable, and/or provide a new paradigm that can change the interior of all vehicles from having carpet or rug on the floor to having flooring made of tile, heavy duty rubber and other materials. These embodiments disclose water proof and flexible materials to replace carpeted interior of vehicles. Moreover, unlike carpet, the disclosed material would not collect and trap any odors or other toxins that can cause allergic reactions from the occupants of the vehicle. In addition, the disclosed materials provide the owner of the vehicle a more modern and industrial look to their vehicle's interior. Unlike carpet, the tiled interior would not be as easily damaged by spills as carpets. The tiled interior would also enhance the aesthetic value of the vehicle, in concert with the ergonomic functionality and utility features as well. Though not all the new vehicular tiles are to be designated as factory standard items, some of them may be integral to determining the future course of any specific vehicular models. The colors, contrast, texture (ornamental feature), and pattern of the tile can be carefully combined to provide the vehicle owner a unique interior environment experience. The resulting tile is of high quality and thus, offers a surface with aesthetic and sanitary qualities. Each distinct area of a vehicle has different requirements and attributes. For example, the driver's area has distinct requirements and attributes than the front passenger area. Likewise, the front passenger area or the trunk of the vehicle for that matter, each has distinct requirements and attributes than the front passenger area or another area of the vehicle. Furthermore, different motor vehicles have different interior lay out and consequently different requirements.

The functional design and development of a modern motor vehicle is typically done by a large team from many different disciplines included within automotive engineering. Automotive design in this context is primarily concerned with developing the visual appearance or aesthetics of the vehicle, though it is also involved in the creation of the product concept. The stylist responsible for the design of the vehicle interior develops the proportions, shape, placement, and surfaces for the instrument panel, seats, door trim panels, headliner, pillar trims, etc. Here, the emphasis is on ergonomics and the comfort of the passengers. The procedure for planning and designing the interior flooring of the vehicle is the same as with exterior design (sketch, digital model and clay model). Just as the placement of an ashtray is strategic, so too should the placement of a style or model of tile be strategic.

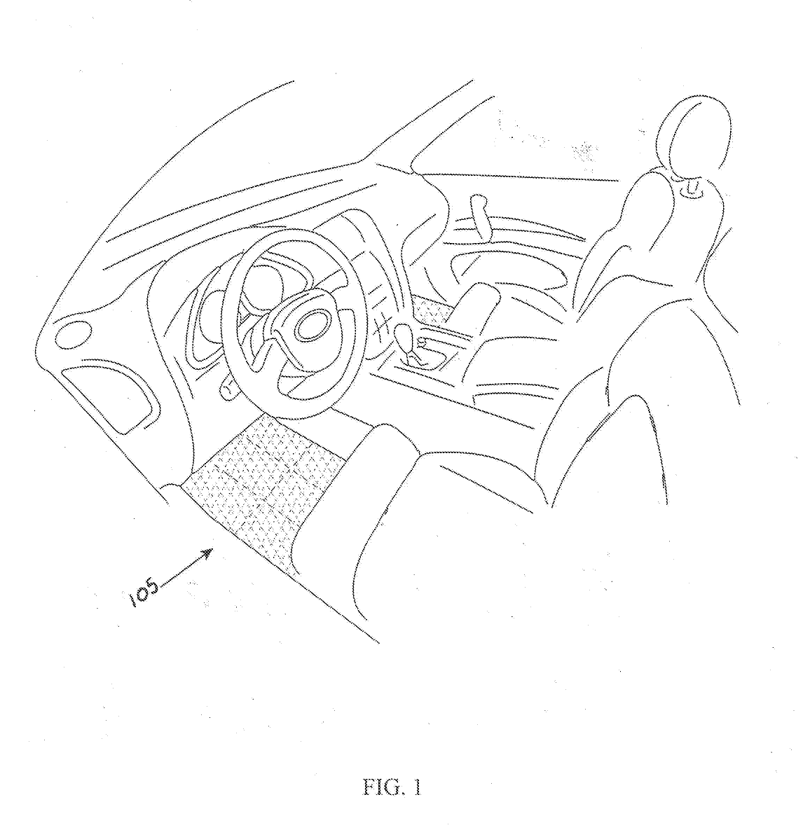

Referring to FIG. 1, the interior of the vehicle is shown with tile 105, which is constructed with durable model rubber material, vinyl, ceramic or other suitable material. In one embodiment, the tile is flexible and waterproof. In another embodiment, tile 105 is steady. Tile 105 is typically positioned on the interior floor surface of a vehicle cab replacing the carpeted flooring of the vehicle. In one embodiment, the entire carpeted area is replaced with tiles. In another embodiment, only selected portion or portions of the interior floor surface is tiled. Tile 105 comes in different shapes and colors as described below.

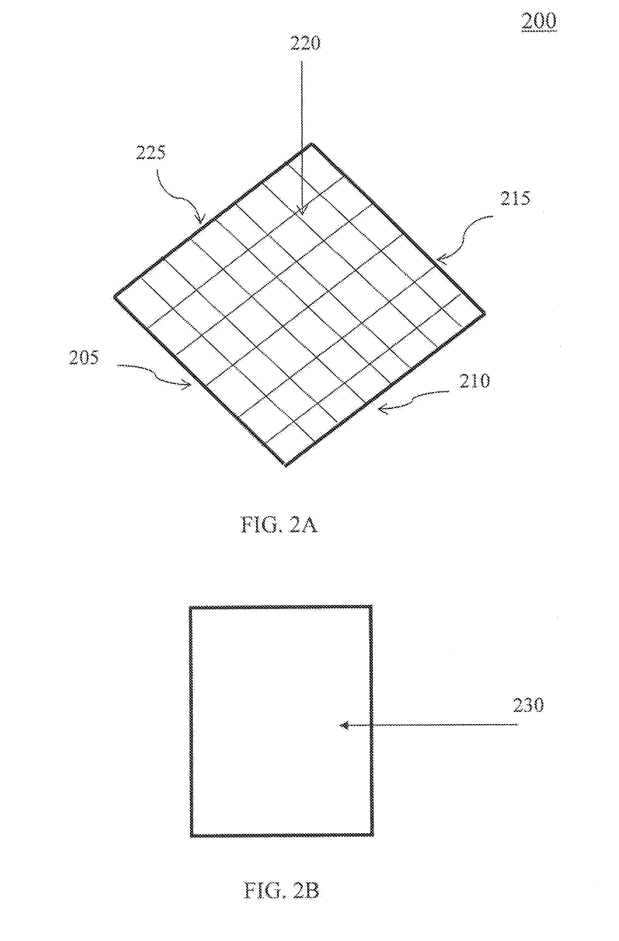

Referring to FIGS. 2A-2B, tile 105 has a first surface area 220 and a second surface area 230. The texture of first surface area 220 provides a waterproof, fire and odor resistant surface and also varies with the position of the tile on the floor. For example, a tile used under the accelerator, brake pedal or clutch pedal may have a different texture than if a tile, which is used near the firewall of the vehicle or on the passenger side of the vehicle. In one embodiment, the texturized surface of tile 105 provides traction for a person to bear their shoes against thereby allowing for easy positioning for the person within their respective seat. In other embodiments, surface of tile 105 is plain with no texture. Yet, in other embodiments, surface of tile 105 has design and patterns reminiscent of tiles used in luxurious homes. Second surface 230 is constructed to adhere to the body or frame of the vehicle. As such, this second surface has different characteristics than the first surface area. Second surface area 230 is designed to interface with the rugged environment of the underside of a vehicle. Second surface area 230 must withstand heat and also absorb the noise generated during driving time. Second surface area 230 may be constructed with groove channels or ridges to accommodate the requirements of the environment where the tile is used.

Tile 105 has side edges 205, 210, 215, and 225. In one embodiment, all the side edges have dimensions that lead to a tile with regular geometric shapes, e.g., square, rectangle, triangle, diamond and the like. In other embodiments, other dimensions that lead to a tile with irregular geometric shapes are used. For example, side edge 205 may be of different length than side edge 215. Likewise, side edge 210 may be of different length than side edge 225.

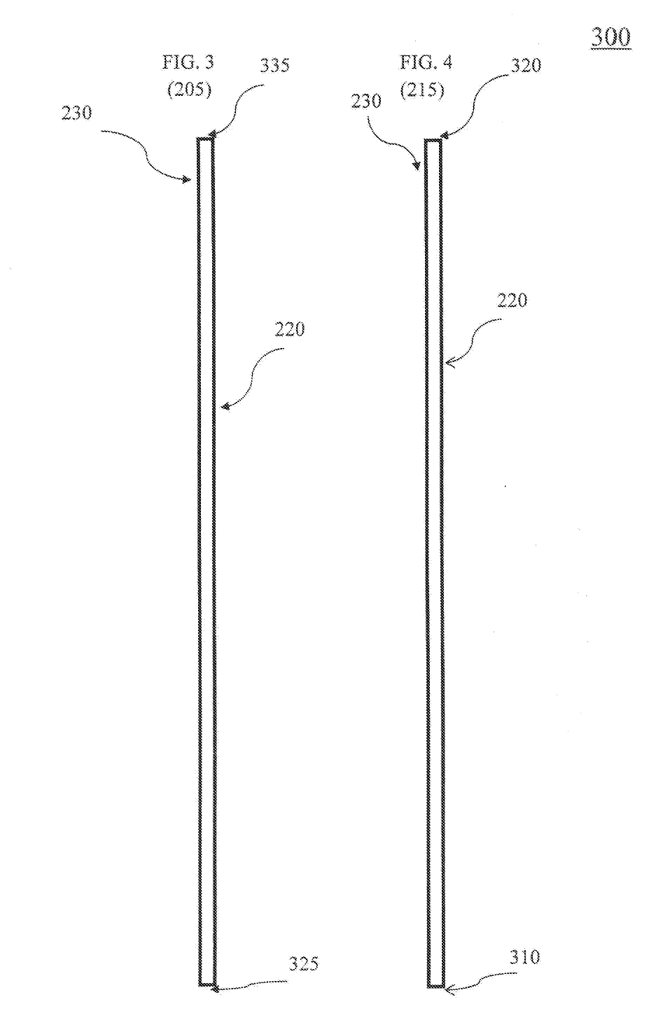

FIG. 3 depicts an exemplary front view of the Vehicular Tile according to an embodiment. As shown in FIG. 3, side edge 205 comprises peripheral lips 235 and 335. Peripheral lips have dimensions in accordance with the position of the tile. In one embodiment, both peripheral lips 325 and 335 have the same dimension. In other embodiments, peripheral lips 325 and 335 have different dimensions and characteristics. For example, if a tile is positioned in a transitional area, the corresponding peripheral lip has a dimension for a proper fit of the tile. When trimming or molding is used, the dimension of one peripheral lip may differ from the other.

FIG. 4 depicts an exemplary rear view of the Vehicular Tile according to an embodiment. As shown in FIG. 4, side edge 215 comprises peripheral lips 320 and 310. As explained above, peripheral lips have dimensions in accordance with the position of the tile. In one embodiment, both peripheral lips 320 and 310 have the same dimension. In other embodiments, peripheral lips 320 and 310 have different dimensions and characteristics. For example, if a tile is positioned in a transitional area, the corresponding peripheral lip has a dimension for a proper fit of the tile. A transitional area is an area that is associated with two different environments requiring different tiles of differing characteristics. When trimming or molding is used, the dimension of one peripheral lip may differ from the other.

FIG. 5 depicts an exemplary Right side view of the Vehicular Tile according to an embodiment. As shown in FIG. 5, side edge 210 comprises peripheral lips 505 and 515. As explained above, peripheral lips have dimensions and characteristics in accordance with the position of the tile.

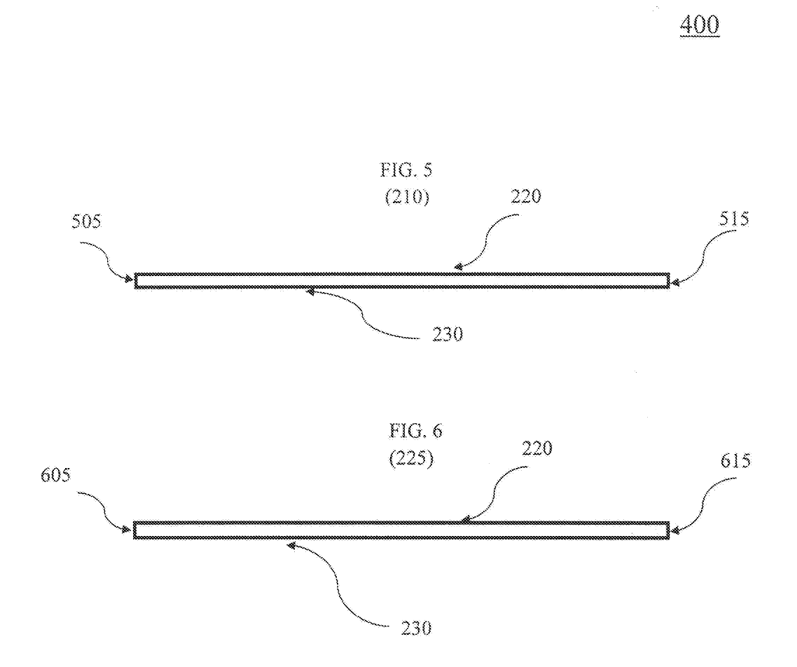

FIG. 6 depicts an exemplary left side view of the Vehicular Tile according to an embodiment. As shown in FIG. 6, side edge 225 comprises peripheral lips 605 and 615. As explained above, peripheral lips have dimensions and characteristics in accordance with the position of the tile.

Although various embodiments which incorporate the teachings of the present invention have been shown and described in detail herein, those skilled in the art can readily devise many other varied embodiments that still incorporate these teachings.

It is contemplated that some of the steps discussed herein may be implemented as software methods or within hardware, for example, as circuitry that cooperates with a processor or robotic apparatus incorporating said processor to perform the various method steps and manufacturing process. Portions of the function/elements described herein may be implemented as a computer program product wherein computer instructions, when processed by a computer, adapt the operation of the computer or robot such that the methods and/or techniques described herein are invoked or otherwise provided. Instructions for invoking the inventive methods may be stored in fixed or removable media, and/or stored within a memory within a computing device operating according to the instructions.

What is claimed is:

1. A vehicular flooring apparatus to be used in lieu and place of carpeted flooring, comprising:
one or more tiles constructed in a manner to be installed in one or more flooring areas of a vehicle to thereby provide finishing surface to the one or more flooring areas of the vehicle;
said one or more tiles having a first surface area, a second surface area and peripheral lips provided on side edges of the configuration of the tile; and
wherein the characteristics of the one or more tiles conform to the geometry and function of the specific area of the vehicle.

2. The vehicular flooring apparatus of claim 1, wherein the one or more flooring areas accommodate one or more distinct and designated functions of the vehicle.

3. The vehicular flooring apparatus of claim 2, wherein one distinct and designated function of the one or more flooring areas is for a driver of the vehicle.

4. The vehicular flooring apparatus of claim 2, wherein one distinct and designated function of the one or more flooring areas is for a passenger of the vehicle.

5. The vehicular flooring apparatus of claim 1, wherein the one or more tiles are of regular geometric shapes.

6. The vehicular flooring apparatus of claim 1, wherein the one or more tiles are of irregular shapes.

7. The vehicular flooring apparatus of claim 1, wherein the first surface area comprises a texture and aesthetic feature associated with the one or more distinct and designated functions of the vehicle.

8. The vehicular flooring apparatus of claim 1 wherein the one or more tiles are of plain color.

9. The vehicular flooring apparatus of claim 1, wherein the one or more tiles are of different patterns and designs.

10. The vehicular flooring apparatus of claim 1, wherein the one or more tiles are of different colors.

11. The vehicular flooring apparatus of claim 1, wherein the second surface area is configured to adhere to the interior architecture of the vehicle.

12. The vehicular flooring apparatus of claim 1, wherein the geometry of the specific area of the vehicle is a function of the specific vehicle.

13. The vehicular flooring apparatus of claim 1, wherein the characteristics of the one or more tiles comprise shape and texture of the one or more tiles.

14. A method for installing a vehicular flooring apparatus, comprising:
(a) preparing a flooring area of a vehicle to install one or more tiles;
(b) obtaining the geometry associated with said flooring area;
(c) preparing the one or more tile by adhering to preparation recommendations for the corresponding tile;
(d) placing said tile in a specific location within said flooring area; and
(e) repeating steps a-d until said flooring area is fully covered.

15. An article of manufacture, comprising:
a vehicular flooring tile having a first surface area, a second surface area and peripheral lips provided on side edges of the configuration of the tile, wherein the tile incorporate characteristics adapted to fit in the interior architecture of a vehicle.

16. The article of manufacture of claim 15, wherein the first surface area comprises a texture and aesthetic feature associated with the one or more distinct and designated functions of the vehicle.

17. The article of manufacture of claim 16, where the first surface area incorporates different colors.

18. The article of manufacture of claim 16, wherein the first surface area incorporates different patterns and designs.

19. The article of manufacture of claim 15, wherein the second surface area is configured to adhere to the interior architecture of the vehicle.

20. The article of manufacture of claim 15, wherein the tile is comfortable, sturdy and waterproof.
